(19) United States
(12) Patent Application Publication
(10) Pub. No.: US 2009/0185319 A1
(43) Pub. Date: Jul. 23, 2009

(54) METHOD OF BREAKING AN OVERCURRENT

(76) Inventor: Hsien-Meng LEE, Taichung City (TW)

Correspondence Address: SINORICA, LLC, 2275 Research Blvd., Suite 500, ROCKVILLE, MD, 20850, US

(21) Appl. No.: 12/018,350

(22) Filed: Jan. 23, 2008

(51) Int. Cl. H02H 3/08; H02H 9/02

(52) U.S. Cl. 361/59; 361/93.6

(57) ABSTRACT

A method of breaking an overcurrent is provided to connect an overcurrent breaking controller in series between an AC power and a load. Thus, when detecting the connected load of which the current generated with the consumed power is higher than a rated current of the overcurrent breaking controller, the overcurrent breaking controller instantly stops the load working, when detecting the current passing through the load that is lower than the rated current, the controller allowing the load to re-work. Thus, the load of which the rated current exceeds is prevented from being replaced, and automatic power shut and recovery are implemented for protection, power saving, easy installation, and energy waste prevention.

### BACKGROUND OF THE INVENTION

1. Field of the Invention

This invention relates to a method that forces electricity economy and particularly to a method of breaking an overcurrent for economizing on energy of a lamp and lantern.

2. Description of Related Art

At the age of energy shortage and green house effect on Earth, in order to economize source of energy and protect environments on Earth, advanced countries' governments has publicly proclaimed to force the use of an energy saving lamp bulb for a lamp and lantern as an illuminator; further in order to economize in electricity, the governments stipulate for the use of each of the lamp and lantern that must be provided with an overcurrent breaking controller sensing a current fed to the lamp and lantern; USA stipulate for the use of energy saving lamp and lantern starting from year 2009.

With reference to FIG. 1, in a conventional method of breaking the overcurrent, a No-Fuse Breaker (NFB) 1 is connected in series in a circuit. One terminal of the NFB 1 is coupled to an AC power 2, while the other terminal is coupled to a lamp and lantern 3. A switch 4 is connected in series between the lamp and lantern 3 and the AC power 2. When the switch 4 turns ON, the lamp and lantern 3 becomes bright. When the lamp and lantern 3 becomes bright and a current generated from its power consumption exceeds a rated current, the NFB 1 is excessively heated and mechanically interrupts the supplied power 2 for protection; namely, the rated current of NFB 1 is 1.5 Ampere. When the lamp and lantern 3 becomes bright, the 2 A current is generated that is more than the current of NFB 1 that is rated to 1.5 A. At this time, a trip occurs inside the NFB 1 because being heated, and disconnection of the lamp and lantern 3 from the AC power 2 is made, thereby the circuit of lamp and lantern 3 stays open.

Consequently, because of the technical defects of described above, the applicant keeps on carving unflaggingly through wholehearted experience and research to develop the present invention, which can effectively improve the defects described above.

### SUMMARY OF THE INVENTION

In a conventional method of breaking an overcurrent, a lamp and lantern 3 is connected in series to a NFB 1; thus, when the lamp and lantern 3 operates, a current generated with a consumed power caused by the lamp and lantern 3 passes through the NFB 1 to make the NFB 1 to be heated and mechanically interrupted, thereby a circuit of the lamp and lantern 3 being open; however, the NFB 1 connected in the method cannot recover and the NFB 1 must be manually again recovered and is inconveniently used for operation.

In this invention, a method of breaking an overcurrent is provided to connect an overcurrent breaking controller in series between an AC power and a load, in which overcurrent breaking controller mainly comprises a trigger control unit made up with a DIAC and a TRIAC, a current transformer, and an overcurrent restraint unit made up with a silicon-controlled rectifier (SCR) and a bridge rectifier. One terminal of the trigger control unit is connected to the AC power, while the other terminal is connected to the current transformer and then the load. The overcurrent restraint unit is connected between the trigger control unit and the current transformer. Thus, when the trigger control unit triggers the load to work, the load starts to consume a power and generates a current in a loop. When detecting the connected load of which the current generated with the consumed power is higher than a rated current of the overcurrent breaking controller, the overcurrent breaking controller instantly stops the load working. When detecting the current passing through the load that is lower than the rated current, the controller allows the work re-work. Thus, the method of breaking the overcurrent may not only prevent a user of ignorance from replacing the a load of which the rated current or power exceeds but also automatically turn off or connect the power supply for protection. Further, No extra power supply does not need to be connected to the controller, thereby power saving and easy installation being achieved and even energy waste being prevented.

### BRIEF DESCRIPTION OF THE DRAWINGS

FIG. 1 is a circuit diagram illustrating a conventional method of breaking an overcurrent;

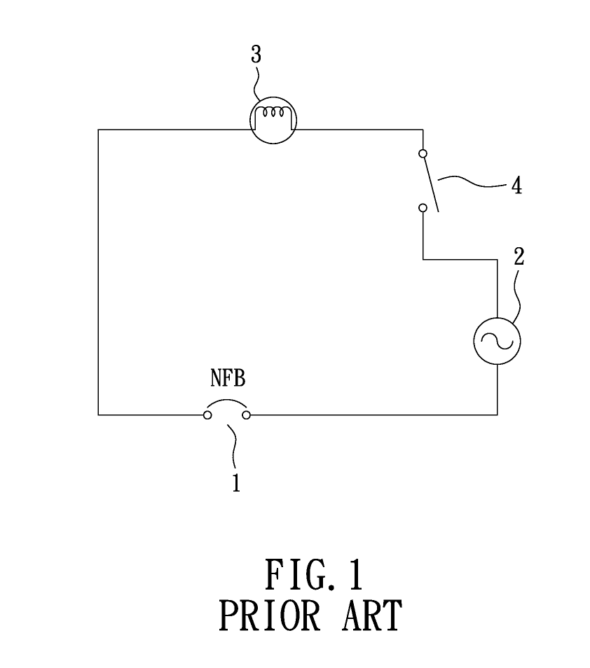

FIG. 2 is a flow chart of a method of breaking an overcurrent according to this invention;

FIG. 3 is a circuit block diagram illustrating the method of breaking the overcurrent in a preferred embodiment of this invention; and

FIG. 4 is a circuit diagram illustrating the method of breaking the overcurrent in a preferred embodiment of this invention.

### DETAILED DESCRIPTION OF THE PREFERRED EMBODIMENTS

Now, the present invention will be described more specifically with reference to the following embodiments. It is to be noted that the following descriptions of preferred embodiments of this invention are presented herein for purpose of illustration and description only; it is not intended to be exhaustive or to be limited to the precise form disclosed.

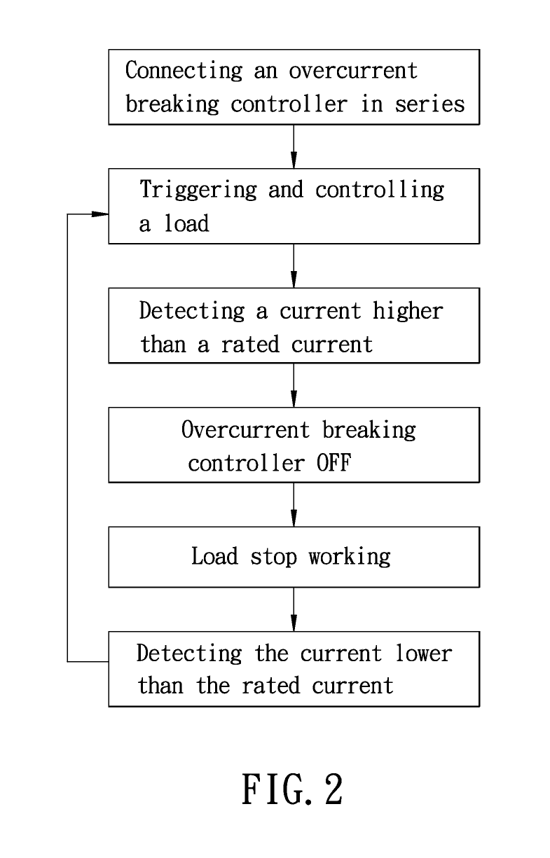

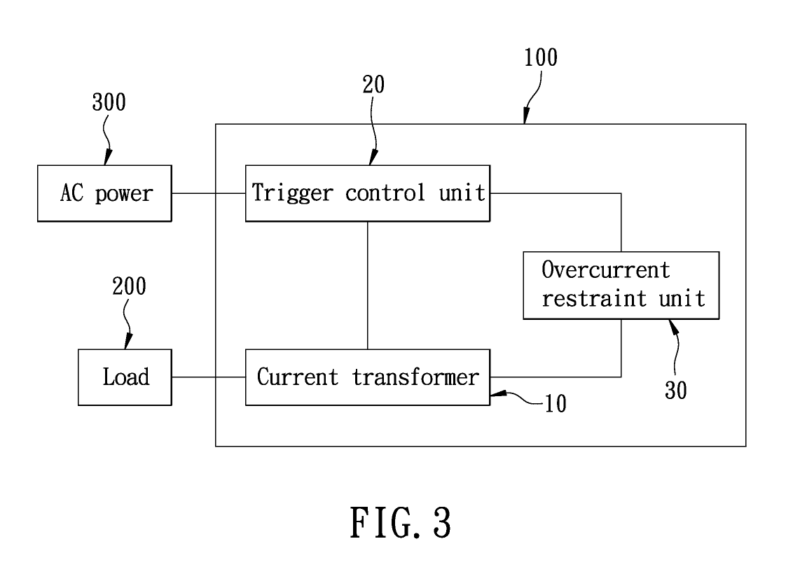

Firstly, with reference to FIGS. 2 through 4, a method of breaking an overcurrent in a preferred embodiment of this invention mainly comprises the following steps:

A. Connecting an overcurrent breaking controller 100 in series:

One terminal of the controller 100 is connected in series to a load 200, while the other terminal is connected in series to an AC power 300.

B. Triggering and controlling the load 200:

With a power source supplied by the AC power 300, the overcurrent breaking controller 100 triggers and controls the load 200.

C. Detecting a current higher than a rated current:

When starting to work, the load 200 consumes a power and generates a current in a loop and the controller 100 starts to detect the current generated with the power consumed by the load 200; when the current is higher than the rated current of the controller 100, step D proceeds.

D. Turning OFF the overcurrent breaking controller 100:

When detecting the current, being generated with the power consumed by the load 200, which is higher than the rated current, the overcurrent breaking controller 100 does not turn ON, and thus a circuit between the load 200 and the AC power 300 stays open, thereby the controller 100 instantly stopping the load 200 working.

E. Detecting a current lower than a rated current:

When detecting the current passing through the load 200 that is lower than the rated current, the controller 100 allows the load 200 to re-work and step B proceeds.

Thus, when detecting the connected load 200 of which the current generated with the consumed power is higher than the rated current of the overcurrent breaking controller 100, the overcurrent breaking controller 100 instantly stops the load 200 working. When detecting the current passing through the load 200 that is lower than the rated current, the controller 100 allows the load 200 to re-work. The load 200 in the preferred embodiment of this invention is the lamp and lantern, in which the overcurrent breaking controller 100 connected in the method of breaking the overcurrent mainly comprises a current transformer 10, a trigger control unit 20, and an overcurrent restraint unit 30.

One terminal of the current transformer 10 is connected to the load 200. The current transformer 10 mainly comprises a primary coil with small number of coils, and a secondary coil with large number of coils. In the preferred embodiment of this invention, a ratio of the primary coil to the secondary coil is set to 1:150. Thus, when a current passing through the load 200 increases, an induced current generated by the primary coil of the current transformer 10 increases and the induced voltage generated by the secondary coil increases, thereby the current transformer 10 being featured with an effect of amplification.

One terminal of the trigger control unit 20 is connected to the AC power 300, and the other terminal is connected to the current transformer 10 to trigger and control the load 200 connected to the other terminal of the current transformer 10. The trigger control unit 20 is further a phase control circuit. In the preferred embodiment of this invention, the phase control circuit is a full wave phase control circuit, mainly comprising a Diode for Alternating Current (DIAC) 21 and a TRIode for Alternating Current (TRIAC) 22, in which the DIAC 21 is connected in series to a Gate of the TRIAC 22. Thus, the DIAC 21 that turns ON may trigger the TRIAC 22 so as to make the DIAC 21 further control the load 200.

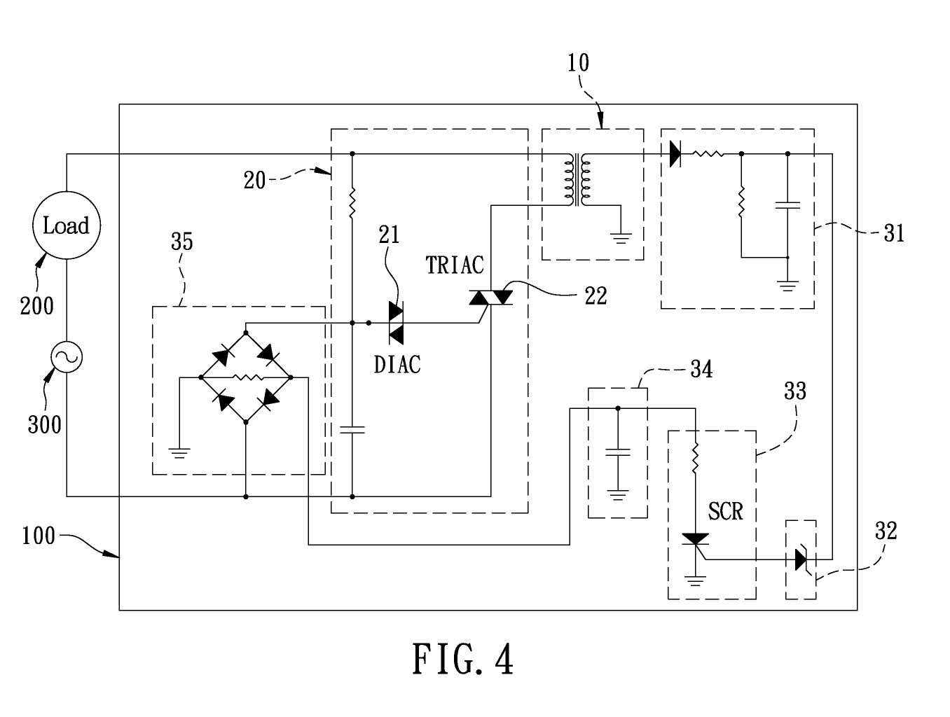

One terminal of the overcurrent restraint unit 30 is connected to the current transformer 10, while the other terminal is connected to the trigger control unit 20. With reference to FIG. 4, the unit 30 comprises a half wave rectifier voltage division circuit 31, a voltage regulator circuit 32, a Silicon-Controlled Rectifier (SCR) 33, a delay circuit 34, and a bridge rectifier 35. An anode terminal of the SCR 33 is connected to the bridge rectifier 35 and further to the DIAC 21 provided in the trigger control unit 20. A terminal of the DIAC 21 that is connected to a charging and discharging capacitor is connected to the bridge rectifier 35. The SCR 33 is further connected to the delay circuit 34. In the preferred embodiment of this invention, the anode of SCR 33 is connected in parallel to a capacitor, the other terminal as Gate that is connected to the voltage regulator circuit 32 is further connected to the half wave rectifier voltage division circuit 31 of which the other terminal is connected to the secondary coil of current transformer 10. In the preferred embodiment of this invention, the voltage regulator circuit 32 connects a Zener diode in series to the Gate terminal of SCR 33. When the induced voltage generated in the secondary coil of current transformer 10 is more than the voltage in the voltage regulator circuit 32, the SCR 33 is made to turn ON and further a voltage drop occurs in the charging and discharging capacitor of DIAC 21 connected to the bridge rectifier 35 so as to make the DIAC 21 not turn ON; at this time, the trigger control unit 20 stays at a non-trigger state.

With reference to FIG. 4 again, in the method of breaking the overcurrent, the overcurrent breaking controller 100 is connected in series between the AC power 300 and the load 200. Thus, the power source supplied by the AC power 300 triggers the TRIAC 22 through the DIAC 21 of the trigger control unit 20 so as to make the DIAC 21 turn ON, and the AC power 300 supplies the power to the load 200 to work. At this time, the induced current is generated in the primary coil of current transformer 10 and converted and amplified into an induced voltage in the secondary coil. The induced voltage is a high voltage and, after being rectified and divided by the half wave rectifier voltage division circuit 31, is detected by the voltage regulator circuit 32. When the current that is generated due to the consumed power of the load 200 is higher than the rated current of the controller 100, namely exceeding the predetermined current, the induced voltage generated in the secondary coil of current transformer 10 is also higher than the setting value of voltage of the regulator circuit 32 and the Zener diode in the regulator circuit 32 is made to turn ON; besides, the Gate terminal of SCR 33 is triggered so as to make the SCR 33 turn ON and constantly ON because of a time delay of the delay circuit 34. At this time, the bridge rectifier 35 also takes effect so as to make the voltage generated by the charging and discharging capacitor of the DIAC 21 connected to the other terminal of the rectifier 35 drop. When the voltage passing through the DIAC 21 is lower than its trigger voltage, in this invention, the trigger voltage is 30V. Here, the DIAC 21 does not turn ON and not trigger the TRIAC 22. The TRIAC 22 does not turn ON, so the circuit between the load 200 and the AC power 300 stays open. At present, the load current passing through the current transformer 10 drops and the load 200 stop working, thereby the overcurrent breaking control being achieved. When the current restraint circuit determines that the current generated from the power consumption of the load 200 is lower than the rated current, the trigger control unit 20 re-trigger the load 200 and the load 200 works again. Thus, the method of breaking the overcurrent not only allows the controller 100 to be simply connected in series between the load 200 and the AC power 300 for protection, but also prevent the load 200 from being randomly replaced with the load 200 of which the current or power is higher than the rated one for achievement of energy economization.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A method of breaking an overcurrent, comprising steps of:
A. connecting an overcurrent breaking controller in series:
one terminal of the controller being connected in series to a load 200 and the other terminal being connected in series to an AC power 300;
B. triggering and controlling the load:
with a power source supplied by the AC power, the overcurrent breaking controller triggering and controlling the load;
C. detecting a current higher than a rated current:
when starting to work, the load consuming a power and generates a current in a loop and the controller starting to detect the current generated with the power consumed by the load; when the current is higher than the rated current of the controller 100, step D proceeding;
D. turning OFF the overcurrent breaking controller:
when detecting the current, being generated with the power consumed by the load, which is higher than the rated current, the overcurrent breaking controller not turning ON, and thus a circuit between the load and the AC power staying open, thereby the controller instantly stopping the load 200 working;
E. detecting a current lower than a rated current:
when detecting the current passing through the load that is lower than the rated current, the controller allowing the load to re-work.

2. The method of breaking the overcurrent according to claim 1, wherein the overcurrent breaking controller comprises:
a current transformer of which a terminal is connected to the load, the current transformer mainly comprising a primary coil with small number of coils, and a secondary coil with large number of coils, when the current passing through the load increases, an induced current generated by the primary coil of the current transformer increasing and the induced voltage generated by the secondary coil increasing;
a trigger control unit of which one terminal is connected to the AC power and the other terminal is connected to the current transformer to trigger and control the load connected to the other terminal of the current transformer; and
an overcurrent restraint unit of which one terminal is connected to the current transformer and the other terminal is connected to the trigger control unit, when the load generates the overcurrent, the induced voltage generated in the secondary coil of current transformer being higher than a rated voltage of the overcurrent restraint unit, and the overcurrent restraint unit being enabled to control the trigger control unit to not turn ON.

3. The method of breaking the overcurrent according to claim 2, wherein the trigger control unit is a phase control circuit.

4. The method of breaking the overcurrent according to claim 3, wherein the phase control circuit is a full wave phase control circuit, mainly comprising at least one Diode for Alternating Current (DIAC) and at least one TRIode for Alternating Current (TRIAC), the DIAC being connected in series to Gate of the TRIAC, thereby an electronic switch being formed.

5. The method of breaking the overcurrent according to claim 2, wherein the overcurrent restraint unit mainly comprises a half wave rectifier voltage division circuit, a regulator circuit, a Silicon-Controlled Rectifier (SCR), and a bridge rectifier, in which one terminal of SCR is connected through the bridge rectifier to the trigger control unit and the other terminal is connected through the voltage regulator circuit to the half wave rectifier voltage division circuit, in which the other terminal of half wave rectifier voltage division circuit is connected to the secondary coil of current transformer, and when the induced voltage generated in the current transformer is more than the voltage in the voltage regulator circuit 32, the SCR 33 is made to turn ON and further a voltage drop occurs in the trigger control unit connected to the bridge rectifier to make the trigger control unit not turn ON.

6. The method of breaking the overcurrent according to claim 5, wherein the voltage regulator circuit mainly comprises a Zener Diode.

7. The method of breaking the overcurrent according to claim 5, wherein the SCR is further connected to a delay circuit.

8. The method of breaking the overcurrent according to claim 7, wherein a capacitor is connected in parallel to Anode of the SCR in the delay circuit.

9. The method of breaking the overcurrent according to claim 1, wherein the load is a lamp and lantern.
